(19) United States
(12) Patent Application Publication
(10) Pub. No.: US 2012/0151976 A1
(43) Pub. Date: Jun. 21, 2012

(54) SECURITY LOCK CONTROL DEVICE FOR AN ACCESS SYSTEM AND ACCESS SYSTEM

(75) Inventor: Richard Koether, Langerwehe (DE)

(73) Assignee: ROBERT BOSCH GMBH, Stuttgart (DE)

(21) Appl. No.: 13/203,642

(22) PCT Filed: Feb. 15, 2010
(86) PCT No.: PCT/EP10/51832

§ 371 Date: Mar. 6, 2012

(30) Foreign Application Priority Data
Feb. 26, 2009 (DE) 10 2009 001 180.3

(51) Int. Cl. E05B 53/00

(52) U.S. Cl. 70/263

(57) ABSTRACT

The invention relates to a security lock control device (1) for an access system (9), which is designed for controlling a security lock, comprising a control panel section (2) via which a user can input a security lock control signal, wherein the control panel section (2) is at least in some areas transparent and/or translucent. The invention further relates to a signaling device by which the control panel section (2) can be backlit with various colours which code the status of the controlled security lock and/or the security lock control device.

### BACKGROUND OF THE INVENTION

The invention relates to a security lock control device for an access system, having a control panel section via which a user can input a security lock control signal, the control panel section being transparent and/or translucent and/or clear at least in regions. The invention also relates to an access system having the security lock control device.

Access systems usually control a plurality of security locks which may be in the form of doors, turnstiles or other separating devices, for example. The access systems are used, for example, to monitor the entrances to areas or buildings, to check the people entering for access authorization and to log their access. Such access systems are used, for example, to monitor working hours, to check authorization, in particular in security-relevant areas inside companies, laboratories, etc. The security locks are controlled using local security lock control devices, a user initiating an access operation, for example, by pressing a button or by inserting an identification card. The security lock is usually opened after the button has been pressed or the card has been inserted, with the result that the user can pass through. Access data, for example the identity or the access time, of the user are optionally logged.

The document DE 100 012 53 A1, which probably forms the closest prior art, describes a device for inputting and/or outputting information, which is used in the fields of application of time management, access control, security technology or building services. The device is designed in such a manner that it fits into a frame which is suitable for flush-mounted and/or surface boxes. On the front side, the device has a touch-sensitive layer via which a user can input signals. A liquid crystal layer and a light are arranged parallel to the touch-sensitive layer and together make it possible to display letters or numbers in a freely programmable manner.

### SUMMARY OF THE INVENTION

The security lock control device according to the invention is suitable and/or designed for an access system which can be used, for example, within the scope of time management, access control, security technology or building services. The security lock control device is suitable and/or designed, in particular, to control, in particular to open and/or close, a security lock, for example a turnstile, a door or another separating device. The security lock control device can also be designed to control a plurality of security locks. The security lock control device is preferably locally arranged in the region of the security lock being controlled, with the result that a user can operate the security lock control device if he would like to pass through the security lock being controlled.

The security lock control device has a control panel section via which a user can input a security lock control signal, the control panel section being transparent and/or translucent and/or clear or at least in regions. The property of transparency is preferably understood as meaning clear, in particular crystal clear, transparency, optionally with colors. The property of translucence is preferably understood as meaning the partial light transmissibility of the control panel, there being no or only impaired or even greatly impaired image transmissibility and/or visual transmissibility in the case of translucence.

The invention proposes that the security lock control device has a signaling device with which the control panel section can be backlit with different colors, the different colors and/or their temporal sequence representing the status of the security lock being controlled and/or the security lock control device in coded form, in particular in color-coded form. The signaling device is designed, in particular, to actively output at least two different colors. However, the signaling device can preferably output three, four or more colors which are each perceived differently by the human eye. For example, the signaling device can output any desired selection of the following colors: red, green, yellow, orange, blue, white etc.

The advantage of the security lock control device according to the invention can be seen in a very high degree of robustness since such signaling devices, optionally with a plurality of luminous sources per color, can be implemented such that they are very unsusceptible to faults. Furthermore, the integration of the security lock control device is simplified since only a few possible signal responses of the security lock control device can or have to be set. Last but not least, advantages can also be discerned in the production costs since the signaling device used and thus the security lock control device is very cost-effective.

In one preferred development of the invention, a proximity sensor and/or a touch sensor is/are integrated and can be used to input the security lock control signal via the control panel. The active region of this sensor is arranged, in particular, such that it is congruent with the preferably rigid control panel section. Since, in order to input the security lock control signal, the user must operate the region backlit by the signaling device with or without contact, he can orient himself to the luminous display such that operation is simplified.

In one preferred design implementation of the invention, the proximity and/or touch sensor has a receiver region which is applied to the inside, that is to say the side inside the device, of the control panel section. The sensor is particularly preferably in the form of a capacitive sensor. The control panel section or its carrier material is thus extended by the function of a simple cover or facing to form a carrier of a functional component, namely the receiver region. The receiver region may be in the form of an adhesively bonded metal layer, for example.

In one possible development of the invention, the security lock control device has a contactless identification mark reader which can be used to input the security lock control signal and/or an authorization code to the security lock control device by the security lock control device reading an identification mark, for example a transponder.

In one preferred design development of the invention, the identification mark reader comprises an antenna region, in particular a receiving region, which is applied to the inside of the control panel section. In this case too, the function of the control panel section or its carrier material is extended by the function of the carrier of the antenna region.

In one particularly preferred development of the invention, the control panel section bears both the receiver region and the antenna region, with the result that the control panel section or the carrier material is in the form of a multifunction component. During operation, an authorization code of an identification mark can first of all be effected by positioning the identification mark in front of the control panel section and a security lock control signal can then be effected by operating the control panel section with or without contact, for example.

In one possible extension of the invention, the security lock control device has one or more interfaces for connecting an external identification mark reader and/or an external operating device. The interface for an external identification mark reader allows a first identification mark reader or a further identification mark reader to be positioned at a distance from the security lock control device. In this case, when integrating the security lock control device, it is possible to arrange the identification mark reader in a region which is on the same side of the security lock or it is possible to position the security lock control device on a first side of the security lock, in particular a secure side, and to position the external identification mark reader on the other side of the security lock.

In a similar manner, it is preferred if the security lock control device has an interface for connecting an external operating device which may likewise be arranged on the opposite side of the security lock. The arrangement of the external components on the non-secure side has the advantage that direct mechanical access to the security lock control device is prevented and destruction of the external components, for example as a result of vandalism, is possible as maximum damage. However, the security of the security lock is not impaired.

In one particularly preferred implementation of the invention, the control panel section has a satinized, frosted and/or calendered glass section and/or is in the form of the latter. Such a surface modification of glass can be produced, for example, by subjecting a glass surface to sandblasting or corundum blasting, by screen printing or by using hydrofluoric acid. In more cost-effective embodiments of the invention, the control panel section may also be formed from plastic, the translucent appearance then being implemented by means of corresponding surface modifications.

In one particularly preferred design embodiment, the security lock control device has a housing, the glass section forming the front side of the housing. As a result, the security lock control device is well protected against environmental influences and simultaneously meets high esthetic requirements.

In one possible development of the invention, the security lock control device has an Ethernet connection for connecting the security lock control device to the access system for the purpose of communication. Information relating to authorizations and/or access data of the users is interchanged, in particular, via the Ethernet connection.

In one possible development of the invention, the security lock control device is designed in such a manner that a supply voltage and/or an additional signal can be transmitted via the Ethernet connection. Such technology is known under the name PoE (Power over Ethernet) and allows, in particular when using an eight-core Ethernet cable, the supply voltage or an additional signal to be transmitted via two cores which are not used by network communication. Alternatively or additionally, the supply voltage and/or the additional signal can also be transmitted via an offset in the other six cores. The additional signal is particularly preferably in the form of an alarm signal, in particular a fire alarm signal, in which case it is optionally additionally preferred if the security lock control device is designed, in terms of programming and/or circuitry, to open the security lock when such an alarm signal is received in order to enable an escape route.

In one advantageous development of the invention, the security lock control device has a second Ethernet connection, a supply voltage and/or an additional signal likewise being able to be transmitted via the second Ethernet connection. In terms of cost, the use of a second Ethernet connection involves little outlay since corresponding modules are available at low cost. As a result of the use of the second Ethernet connection, which is preferably likewise equipped with PoE functionality, to set up redundant communication between the access system and the security lock control device. The advantage of a redundant Ethernet connection is that, if the first Ethernet connection fails or there is a fault in its supply lead, the second Ethernet connection can redundantly undertake the function of the first Ethernet connection. The redundant supply relates to network communication and/or to the supply voltage and/or to the additional signal.

### BRIEF DESCRIPTION OF THE DRAWINGS

Further features, advantages and effects of the invention emerge from the following description of a preferred exemplary embodiment of the invention and from the accompanying figures, in which:

FIG. 1 shows a diagrammatic three-dimensional illustration of a security lock control device as a first exemplary embodiment of the invention;

FIG. 2 shows a diagrammatic rear view of the control panel section of the security lock control device in FIG. 1;

FIG. 3 shows a highly diagrammatic cross-sectional illustration in the region of the control panel section of the security lock control device in FIG. 1;

FIG. 4 shows a diagrammatic illustration of a first possibility for integrating the security lock control device;

FIG. 5 shows a second possibility for integrating the security lock control device from the preceding figures;

FIG. 6 shows a diagrammatic block illustration of the internal structure of the security lock control device from the preceding figures;

FIG. 7 shows a diagrammatic illustration of the information technology architecture of an access system having one or more security lock control devices according to the preceding figures.

### DETAILED DESCRIPTION

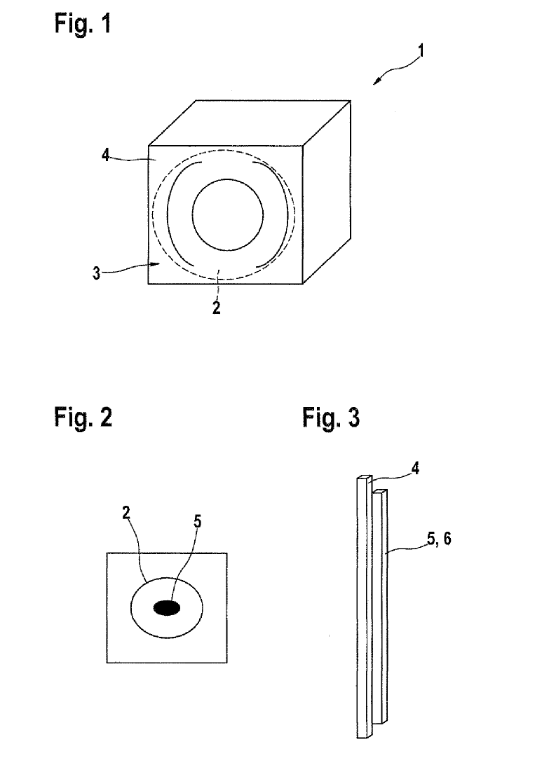

FIG. 1 shows a diagrammatic three-dimensional illustration of a security lock control device 1 in the form of a door control device which is designed to control an automated door or security lock. The security lock control device 1 is able to output control signals for the door, with the result that the latter is opened and closed. The security lock control device 1 is also designed to receive status signals from the door with regard to the status open—closed—faulty.

The security lock control device 1 is in the form of a flat cuboid having a width of 11 cm, a depth of 5 cm and a height of likewise 11 cm, for example.

A control panel section 2 is arranged on a glass plate 4 on the front side 3 of the security lock control device 1 and can be used by a user to operate the security lock control device 1. The control panel section 2 is translucent at least inside the dashed region, in particular is provided with a frosted glass surface; optionally, the entire rectangular front surface of the glass plate 4 may also be formed with a translucent glass surface. The translucent glass surface results in scattering of light radiation which penetrates to the outside from the inside of the housing. The glass plate 4 may be frosted, for example, by subjecting the glass plate 4 to corundum blasting or the effect of acid.

A signaling device (not illustrated) is arranged inside the security lock control device 1 and can backlight the control panel section 2 with different colors, the currently displayed color being coded status information relating to the door or the security lock control device. For example, provision may be made for the control panel section 2 to be backlit with a blue color if the security lock control device 1 is ready for operation. Green backlighting could mean that the door being controlled is open, and red illumination signals that the door being controlled is locked or closed.

A capacitive sensor, the receiver region 5 of which is applied to the rear side of the glass plate 4 facing the inside of the device in the region of the control panel section 2, is arranged in the security lock control device 1. FIG. 2 shows a diagrammatic rear view of the glass plate 4, the receiver region 5 being in the form, for example, of a copper layer in an oval shape which is congruent with or overlaps the control panel section 2. The glass plate 4 thus becomes a capacitively sensitive glass plate 4, in the central region of which a touch-sensitive and/or approach-sensitive location is arranged.

FIG. 3 shows a highly diagrammatic cross-sectional illustration of the glass plate 4 of the control device 1 from FIG. 1, an optional antenna 6 for a contactless identification mark reader being illustrated on the rear side. It is also possible for the receiver region 5 and the antenna 6 to be arranged on the same sheet of glass 4 which then forms a multifunctional element.

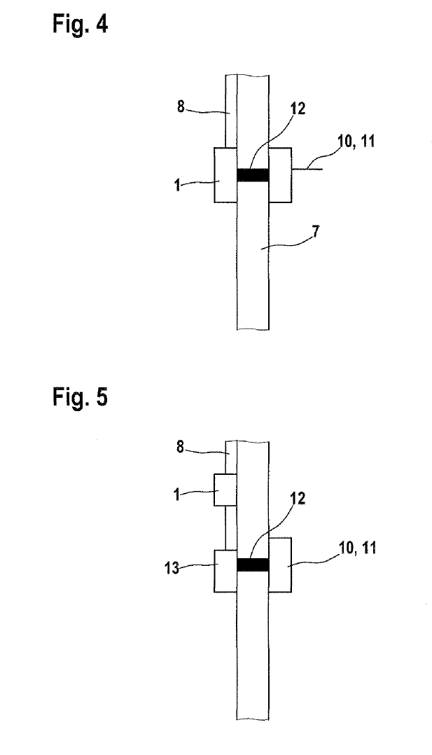

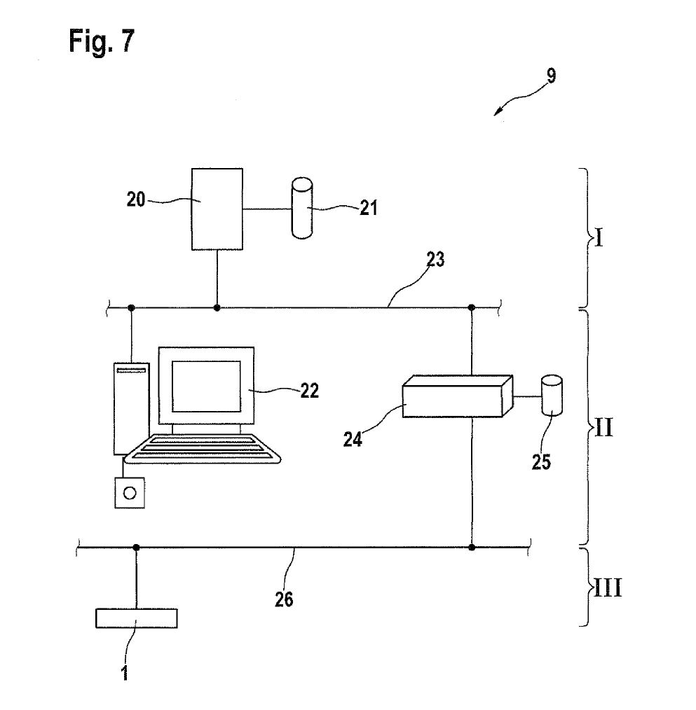

FIG. 4 shows a first possibility for integrating the security lock control device 1 in the region of a partition 7, for example a wall. The region which is protected by a door (not illustrated) is arranged on the left-hand side with respect to the partition 7 and the unprotected region is arranged on the right-hand side. As emerges from the illustration, the security lock control device 1 is positioned in the protected region. A network cable 8 which connects the security lock control device 1 to a superordinate access system 9 (see FIG. 7) is also arranged. In contrast, a card reader 10 and/or an operating device 11, for example a push-button, which are connected to the security lock control device 1 for signaling purposes via a connection 12, are situated on the unprotected outer side.

Starting from the unprotected side, the external card reader 10 and the external operating device 11 (also called REX (request to exit)) make it possible for a user to input a security lock control signal by virtue of the user activating the card reader 10 and the operating device 11. The security lock control device 1 has a correspondingly designed interface for connecting these components.

FIG. 5 shows a second possible integration of the security lock control device 1 from the preceding figures, the security lock control device 1 being connected for signaling purposes to an internal card reader 13, in contrast to the preceding integration.

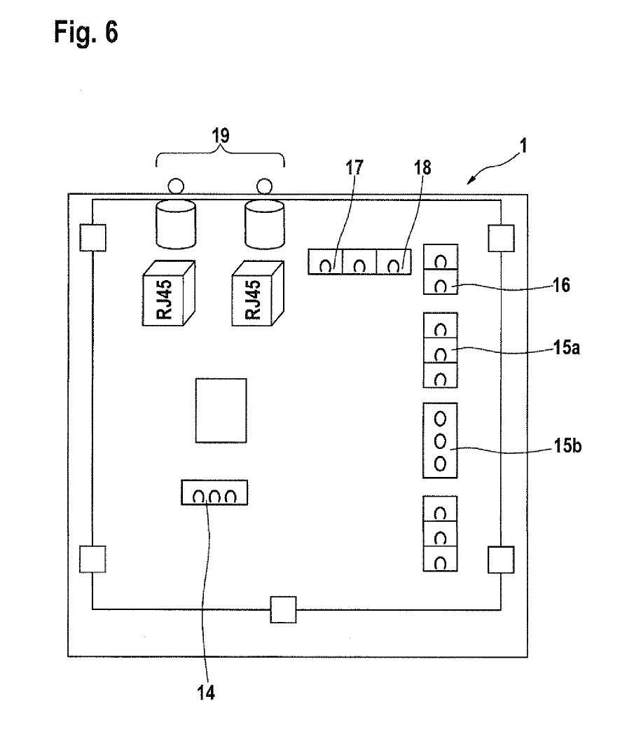

FIG. 6 shows a diagrammatic block illustration of the internal structure of the security lock control device 1 and illustrates, in particular, the plurality of possible interfaces. A service interface 14, which is formed by an RS232 port for example, is centrally arranged. A plurality of output interfaces which can output or accept analogue or digital signals for controlling the door or the internal or external components 10, 11, 13 are then illustrated. An interface 15a may be in the form of an input for the external operating device 11 for example, and an interface 15b may be in the form of an input for the external card reader 13 or 10. Further inputs 16 relate to signals concerning the status of the door. In one possible embodiment of the invention, additional inputs 17 for a voltage supply and inputs 18 for a redundant voltage supply or a voltage supply signal are provided.

In order to communicate with the access system 9, the security lock control device 1 has two Ethernet connections 19. The Ethernet connections 19 allow the security lock control device 1 to be redundantly connected to the access control system 9. One or both of the Ethernet connections 19 may optionally be equipped with PoE capability which makes it possible to feed supply voltage and/or alarm signals via the standard Ethernet cables.

FIG. 7 finally shows a diagrammatic structure of an architecture of an access system 9. A data management server (DMS) 20 comprising a data management system 21 is arranged in a first layer I. The data which pass to the individual security lock control devices 1 and come from the latter are acquired in the layer I. The data management server 20 is optionally connected to a workstation 22 which makes it possible to comfortably input the control data. A first Ethernet connection 23 is used to connect the layer I to a layer II which comprises a plurality of main access control devices 24 which can each access its own database 25. For example, such a main access control device 24 is provided for each logical section of a monitoring region, for example of one building in the case of a plurality of buildings. The main access control device 24 is used to record the current movements and access data.

A further Ethernet connection 26 is used to connect the main access control devices 24 to a plurality of security lock control devices 1 which are locally arranged in the region of the doors or security locks to be controlled and form a third layer III.

It is optionally possible to design the further Ethernet connection 26 to be redundant, for example by coupling the two Ethernet connections 19 of each security lock control device 1 to two different network regions.

1. A security lock control device (1) for an access system (9), which is designed to control a security lock,
having a control panel section (2) via which a user can input a security lock control signal, the control panel section (2) being transparent and/or translucent and/or clear at least in regions,
characterized by
a signaling device with which the control panel section (2) can be backlit with different colors which code a status of the access system (9).

2. The security lock control device (1) as claimed in claim 1, characterized by a touch sensor (5) configured to input the security lock control signal via the control panel.

3. The security lock control device (1) as claimed in claim 2, characterized in that the touch sensor has a receiver region (5) which is applied to the inside of the control panel section (2).

4. The security lock control device (1) as claimed in claim 1, characterized by a contactless identification mark reader (6) configured to provide a security lock input.

5. The security lock control device (1) as claimed in claim 4, characterized in that the identification mark reader has an antenna region (6) which is applied to the inside of the control panel section (2).

6. The security lock control device (1) as claimed in claim 1, characterized by an interface for connecting an external identification mark reader (13, 10).

7. The security lock control device (1) as claimed in claim 1, characterized in that the control panel section (2) has a satinized, frosted and/or calendered glass section (4) or is in the form of the latter.

8. The security lock control device (1) as claimed in claim 7, characterized by a housing, the glass section (4) forming the front side of the housing.

9. The security lock control device (1) as claimed in claim 1, characterized by an Ethernet connection (19) for connecting the security lock control device (1) to the access system (9) for the purpose of communication.

10. The security lock control device (1) as claimed in claim 9, characterized in that a supply voltage can be transmitted via the Ethernet connection (19).

11. The security lock control device (1) as claimed in claim 9 or 10, characterized by a second Ethernet connection (19), a supply voltage and/or an additional signal being able to be transmitted via the second Ethernet connection.

12. An access control system, characterized by a security lock control device (1) as claimed in claim 1.

13. The security lock control device (1) as claimed in claim 1, wherein the status of the access system (9) is a status of the security lock being controlled.

14. The security lock control device (1) as claimed in claim 1, wherein the status of the access system (9) is a status of the security lock control device.

15. The security lock control device (1) as claimed in claim 1, wherein the status of the access system (9) is a status of the security lock being controlled and the security lock control device.

16. The security lock control device (1) as claimed in claim 4, wherein the input is a-security lock control signal.

17. The security lock control device (1) as claimed in claim 4, wherein the input is an authorization code.

18. The security lock control device (1) as claimed in claim 4, wherein the input is a-security lock control signal and an authorization code.

19. The security lock control device (1) as claimed in claim 9, characterized in that an additional signal can be transmitted via the Ethernet connection (19).

20. The security lock control device (1) as claimed in claim 9, characterized in that a supply voltage and an additional signal-can be transmitted via the Ethernet connection (19).
